(19) United States
(12) Patent Application Publication
(10) Pub. No.: US 2010/0162234 A1
(43) Pub. Date: Jun. 24, 2010

(54) METHOD FOR INSTALLING APPLICATION AND COMPUTER SYSTEM THEREOF

(75) Inventors: Jung-Chung Wang, Taipei (TW); Jui-Hsiang Shih, Taipei (TW); Ching-Jr Lee, Taipei (TW); Ching-Hao Chen, Taipei (TW); Li-Chin Chou, Taipei (TW); Shih-Shyang Huang, Taipei (TW); Chung-Yang Sheng, Taipei (TW)

Correspondence Address: KIRTON AND MCCONKIE, 60 EAST SOUTH TEMPLE,, SUITE 1800, SALT LAKE CITY, UT, 84111, US

(73) Assignee: ASUSTEK COMPUTER INC., Taipei (TW)

(21) Appl. No.: 12/638,779

(22) Filed: Dec. 15, 2009

(30) Foreign Application Priority Data
Dec. 22, 2008 (TW) 097150130

(51) Int. Cl. G06F 9/445

(52) U.S. Cl. 717/178

(57) ABSTRACT

The invention relates to a method for installing an application used in a computer. The computer includes a user information reading program, and the method includes the steps as follows. An application is downloaded to the computer, and the application includes a piece of first user information. The user information reading program reads the first user information included in the application after the application is downloaded, and the application is installed according to the first user information.

### FIELD OF THE INVENTION

The invention relates to a method for installing an application and, more particularly, to a method for installing an application used in a computer.

### BACKGROUND OF THE INVENTION

A computer is composed of much hardware such as a display screen, a keyboard, a mouse, a graphics card, a network adapter, a memory and a lot of storage devices. To control the hardware efficiently, an operating system (OS) appears. The OS is a program controlling the computer hardware and software, and it is also the core and base of the computer system. It takes charge of basic affairs such as managing and configuring memories, deciding the supplying order of the system source, controlling the input and output devices, operating the network and controlling file system.

The OS may have various types. Different OSs in different configuration of electronic device may vary from simple one to complex one. For example, a mobile phone is installed with an embedded system, while a supercomputer is installed with an OS. Many OS manufacturers give different definitions of the OS. For example, some OSs are integrated with graphical user interfaces (GUIs), and some OSs only use textual interfaces. On the market nowadays, a personal computer or a notebook computer uses the OS integrated with the GUI mainly because the OS integrated with the GUI is relatively easy to be operated. Besides the well known Microsoft Windows and Mac OS, the Linux OS is also a representative OS used widely.

The Linux OS has many special functions and advantages. For example, anyone may download, use and modify the source codes freely, the class of the hardware used by the Linux operating system is not high class, functions thereof are strong and stable among free software, multiple users are allowed to work online at the same time, the source is distributed fairly, and it is suitable for an embedded system with a small kernel. However, the Linux OS also has some limitations in use. The Linux OS is managed in a terminal mode of commands, and that is, the user has to know some operation instructions of the Linux OS well to operate the computer having the Linux OS. Compared with the Windows OS which may be operated just by clicking on the icon via a mouse, the Linux OS has some operation limitations for the user unfamiliar with the instruction operation. However, problems often occur when a user installs applications under the Linux OS. For example, when the user wants to install an application under the Linux OS, he or she may face troubles as below.

(a) The user has to spend some time in searching for and downloading a preferred application or digital content from the Internet, and he or she also needs to search for the digital content corresponding to the application or the application corresponding to the digital content.
(b) The user has to select the install mechanisms in the Linux OS to install the application or the digital content downloaded from the Internet.
(c) The user has to finish complex installing process by different packages and libraries.
(d) The user needs to search for related software to execute or edit the digital content.
(e) The processing of installing the application is difficult (for example, the application is installed via a terminal mode of commands).
(f) During the installing and uninstalling process of the application, an improper operation may cause the Linux OS to be instable.

### SUMMARY OF THE INVENTION

The invention relates to a method for installing an application used in a computer. The computer includes a user information reading program, the method includes the steps as follows. An application is downloaded to the computer, and the application includes a first user information. The user information reading program reads the first user information included in the application after the application is downloaded and installs the application according to the first user information.

Another aspect of the invention provides a computer system used when a file is downloaded via the Internet and when the file is used. The computer system includes a network device by which an application is downloaded via the Internet. The application includes a first user information, a storage device connected to the network device for storing the downloaded application, a user information reading unit connected to the storage device. The user information reading unit reads the first user information included in the application after the network device downloads the application, and installs the application according to the first user information.

Via the technique means above, when the user downloads the application from the Internet and installs the application in the computer having a Linux OS, he or she does not need to install the application via complex steps. The user only has to perform one step (a click) to download the application from the Internet and install the application. Via the main idea of the invention, when the user downloads a multimedia audio/video file or a text data file, the installing information corresponding to the multimedia audio/video file or the text data file also may be obtained. This may improve the efficiency when the user uses the computer system having the Linux OS.

### BRIEF DESCRIPTION OF THE DRAWINGS

These and other features, aspects and advantages of the present invention will become better understood with regard to the following description, appended claims, and accompanying drawings.

FIG. 1 is a functional block diagram showing a computer system in a preferred embodiment of the invention;

FIG. 2(a) is a flow chart showing the method for installing an application in a preferred embodiment of the invention;

FIG. 2(b) is a flow chart showing the method for uninstalling the application in a preferred embodiment of the invention;

FIG. 3(a) and FIG. 3(b) are flow charts showing the method for installing the application in a preferred embodiment of the invention; and

FIG. 4(a) and FIG. 4(b) are flow charts showing the method for installing the application in another preferred embodiment of the invention.

### DETAILED DESCRIPTION OF THE PREFERRED EMBODIMENT

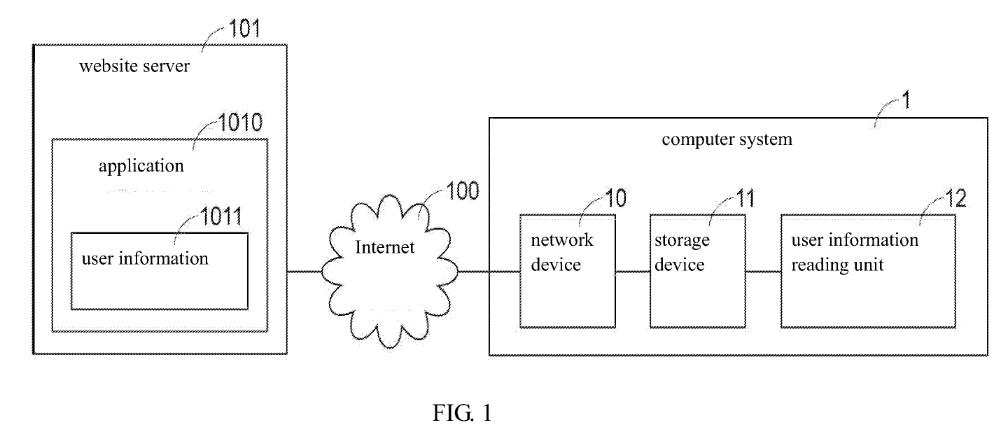

FIG. 1 is a functional block diagram showing a computer system in an embodiment of the invention. The computer system has a Linux operating system (OS). As shown in FIG. 1, the computer system 1 includes a network device 10, a storage device 11 and a user information reading unit 12 includes a user information reading program. The network device 10 logs on to a website server 101 via the Internet 100 to download an application 1010, and the application 1010 includes a user information 1011. The storage device 11 stores the application 1010 downloaded by the network device 10. The main technique means of the invention is having a user information reading unit 12. After the network device 10 downloads the application 1010 by logging on to the website server 101 via the Internet 100, the user information reading unit 12 reads the user information 1011 included in the application 1010 and executes an application installing program code in the user information 1011 to install the application 1010 subsequently. In addition, the user information reading unit 12 may be triggered by an application uninstalling command to read the user information 1011 included in the application 1010 and execute an application uninstalling program code included in the user information 1011 to uninstall the application 1010.

From the above, in the method for installing the application, the application 1010 including the user information 1011 is provided by the website server 101 for the user to download. The user information 1011 includes the application installing program code and the application uninstalling program code, and the user information reading unit 12 is used to read the user information 1011. That is, the user only clicks on an icon of “click and download the application” during the whole downloading and installing process. Other operations are finished automatically. In a conventional computer system installed with a Linux OS, if the application needs to be installed, the computer system should be systematically managed in a terminal mode of the commands. That is, the user should know some special commands belonging to the Linux OS to operate the computer having the Linux OS. For example, when the user downloads a new application and installs the application in a computer having the Linux OS, first, the user needs to decide the installing path of the application, and then the terminal mode of commands is entered to input the commands. The inputted commands may be changing the property of the file, decompressing the file and so on. Every step in installing the application is confirmed by the user in the terminal mode of the commands. For example, whether the installing position is correct and whether the file should be copied to a target file folder is inquired. When the application is uninstalled (that is, the application is removed), the user also has to input commands and confirm every step. Since the installing steps are complex, if one step has some errors, the application cannot be installed or removed completely, or the application cannot be installed. This makes the computer system instable. Thus, the method for installing an application in a computer system having the Linux OS disclosed in the invention improves the conventional technology. Not only the using efficiency of the computer system having the Linux system used by the user is improved a lot, and the stableness of the computer system is also improved. The technique means of the invention is illustrated hereinbelow.

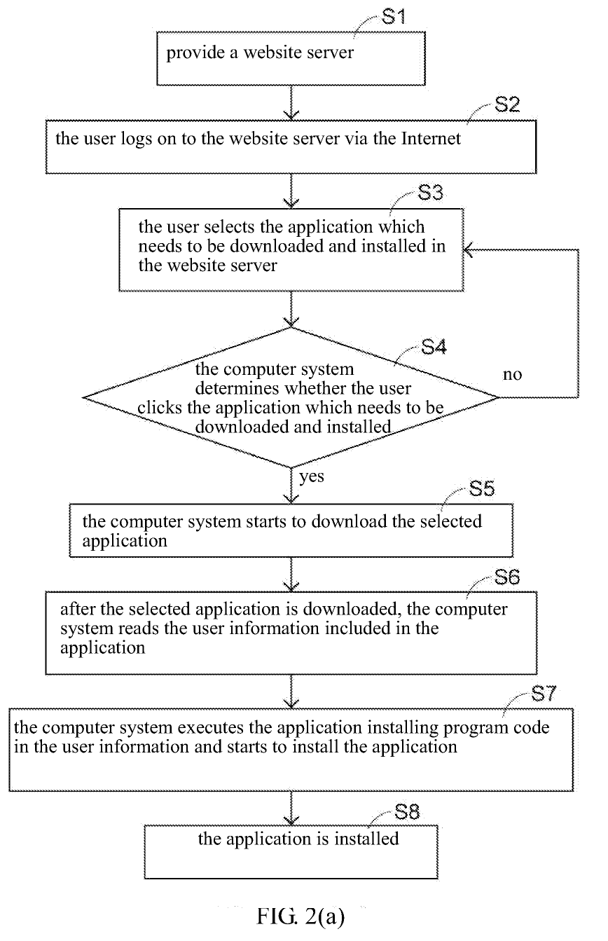

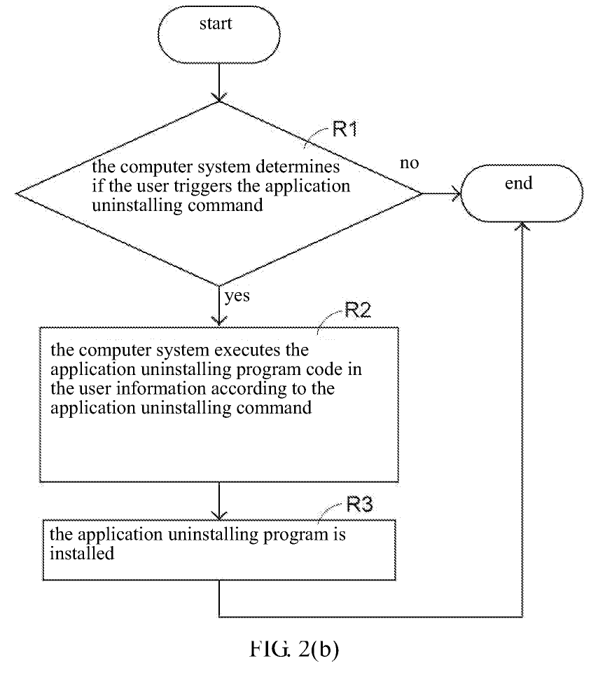

FIG. 2(a) and FIG. 2(b) are flow charts showing the method for installing the application in an embodiment of the invention. The method for installing the application is used in the computer system stated above. As shown in FIG. 2(a), at first, a website server is provided (step S1). The user logs on to the website server via the Internet (step S2). The user selects the application which needs to be downloaded and installed in the website server (step S3). The computer system determines whether the user clicks on the application which needs to be downloaded and installed (step S4). If the user clicks on the application which needs to be downloaded and installed, the computer system starts to download the selected application (step S5). After the application is downloaded, the computer system reads the user information included in the application (step S6). The computer system executes the application installing program code in the user information and performs the installing process of the application (step S7). The application is installed (step S8). In addition, the user may uninstall the application at any time after it is installed. FIG. 2(b) is a flow chart showing the uninstalling process in a preferred embodiment of the invention. First, the computer system determines if the application uninstalling command is triggered by the user (step R1). If the user triggers the application uninstalling command, the computer system executes the application uninstalling program code in the user information according to the application uninstalling command (step R2). Then, the application is uninstalled (R3).

As shown in the schematic diagram showing the method for installing the application in the above, using the technique means in the invention, no matter the application is installed or uninstalled, the user may install or uninstall the application easily by one click. This may overcome the disadvantage of the conventional technology and achieve the main objective of the invention. The technique means of the invention is illustrated hereinbelow with different embodiments.

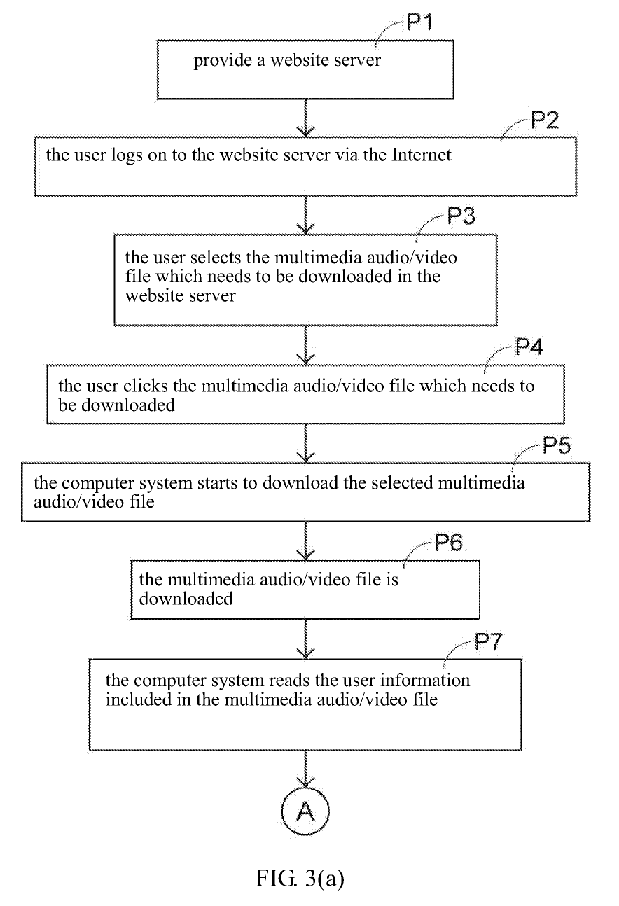

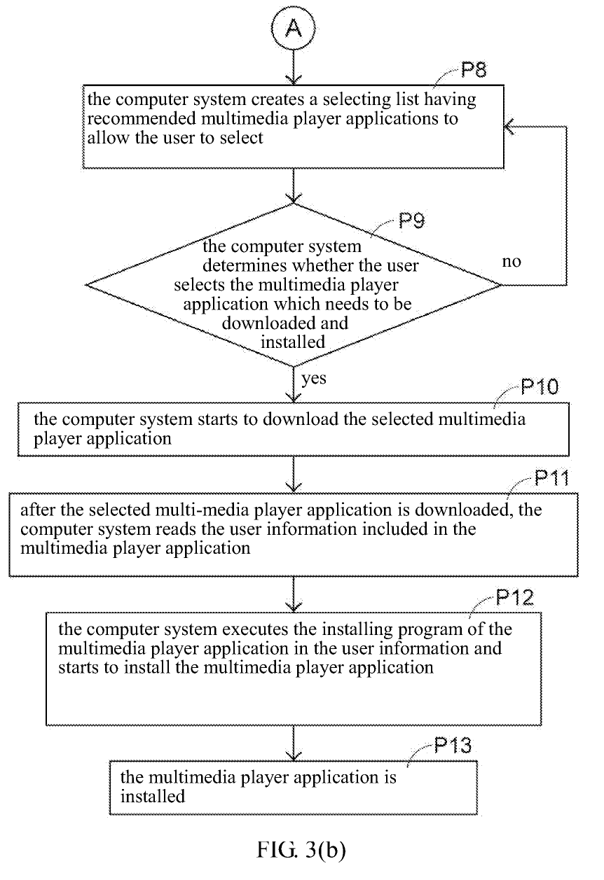

FIG. 3(a) and FIG. 3(b) are flow charts showing the method for installing the application in a preferred embodiment of the invention. The illustration in the embodiment also may be adapted to the architecture in the computer system in FIG. 1. As shown in FIG. 3(a) and FIG. 3(b), first, a website server is provided (step P1). The user logs on to the website server via the Internet (step P2). A multimedia audio/video file which needs to be downloaded is selected in the website server (step P3). The user clicks on the selected multimedia audio/video file (step P4). The computer system starts to download the selected multimedia audio/video file (step P5). The multimedia audio/video file is downloaded (step P6). The computer system reads the user information included in the multimedia audio/video file (step P7). At that moment, the computer system creates a selecting list having recommended multimedia player applications to allow the user to select (step P8). Then, the computer system determines if the user clicks on the selected multimedia player applications which need to be downloaded and installed (step P9). If the user has clicked on the selected multimedia player application which needs to be downloaded and installed, the computer system starts to download the selected multimedia player application (step P10). After the multimedia player application is downloaded, the computer system reads the user information included in the multimedia player application (step P11). The computer system executes the multimedia player application installing program code in the user information and starts to install the multimedia player application (step P12). Then, the multimedia player application is installed (step P13).

If the multimedia audio/video file is an audio file (such as a mp3 file or a way file), at least a music player application adapted to the audio file is provided in the selecting list having recommended multimedia player applications to allow the user to select. If the multimedia audio/video file is an image file, at least an image display application adapted to an image file is provided in the selecting list having the recommended multimedia player applications is recommended to allow the user to select. In addition, if the user already has a music player application for playing the audio files or an image display application for displaying the image files, a newer version of music player application or an image display application may be provided in the selecting list having the recommended multimedia player applications to allow the user to download.

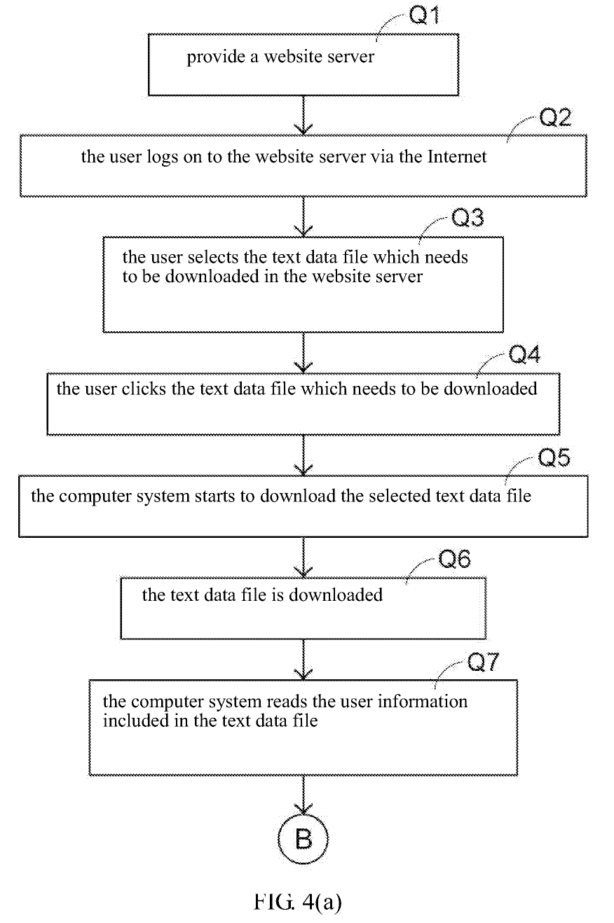

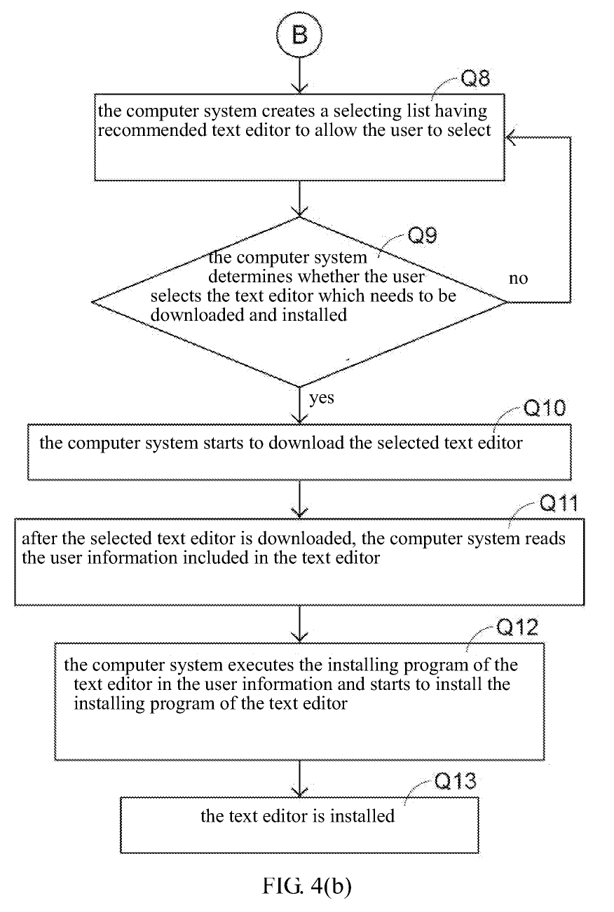

FIG. 4(a) and FIG. 4(b) are flow charts showing the method for installing the application in another preferred embodiment of the invention. The method in the embodiment also may be adapted to the architecture of the computer system in FIG. 1. As shown in FIG. 4(a) and FIG. 4(b), a website server is provided (step Q1). The user logs on to the website server via the Internet (step Q2). The text data file which needs to be downloaded is selected in the website server (step Q3). The user clicks on the selected text data file (step Q4). The computer system starts to download the selected text data file (step Q5). The text data file is downloaded (step Q6). The computer system reads the user information included in the text data file (step Q7). At that moment, the computer system creates a selecting list having recommended text editors to allow the user to select (step Q8). Then, the computer system determines if the user has clicked on the selected text editor which need to be downloaded and installed (step Q9). If the user has clicked on the selected text editor which needs to be downloaded and installed, the computer system starts to download the selected text editor (step Q10). After the text editor is downloaded, the computer system reads the user information included in the text editor (step Q11). The computer system executes a text editor installing program code in the user information and starts to install the text editor (step Q12). The text editor is installed (step Q13). Similar with the embodiment in FIG. 3(a) and FIG. 3(b), in this embodiment, if the user already has an text editor which may edit the text data file, the selecting list having the recommended text editors may provide new versions of text editor to allow the user to download.

To sum up, via the technique means of the invention, when the user downloads the application from a website to a computer having a Linux OS and installs the application, he or she does not need to install the application via complex steps. During the downloading and installing process of the application, the user only has to perform one step (one click). Via the main idea of the invention, when the user downloads the multimedia audio/video file or the text data file from the website, the application installing information corresponding to the multimedia audio/video file or the text data file may be obtained. Thus, the efficiency of the user using the computer system executing the Linux OS is improved, and the main objective of the invention is achieved.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for installing an application used in a computer, wherein the computer includes a user information reading program, the method comprising the steps of:
downloading the application to the computer, wherein the application includes a first user information; and
reading the first user information included in the application by the user information reading program and installing the application according to the first user information after the application is downloaded.

2. The method for installing the application according to claim 1, wherein the first user information includes an application installing program code.

3. The method for installing the application according to claim 1, further comprising the steps of:
reading the first user information included in the application by the user information reading program triggered by an application uninstalling command and uninstalling the application according to an application uninstalling program code included in the first user information.

4. The method for installing the application according to claim 1, wherein the application further comprises a multimedia audio/video file, and the multimedia audio/video file includes a second user information.

5. The method for installing the application according to claim 4, further comprising the steps of:
downloading the multimedia audio/video file via an Internet; and
reading the second user information included in the multimedia audio/video file by the user information reading program and providing a selecting list having recommended multimedia player applications after the multimedia audio/video file is downloaded.

6. The method for installing the application according to claim 5, wherein the multimedia audio/video file is an audio file, and the selecting list having the recommended multimedia player applications provides a music player application or a new version of music player application to allow the user to select and download.

7. The method for installing the application according to claim 5, wherein the multimedia file is an image file, and the selecting list having the recommended multimedia player applications provides an image display application or a new version of image display application to allow the user to select and download.

8. The method for installing the application according to claim 1, wherein the application further comprises a text data file, and the text data file includes a third user information.

9. The method for installing the application according to claim 8, further comprising the steps of:
downloading the text data file via an Internet; and
reading the third user information included in the text data file by the user information reading program and providing a selecting list having recommended text editors after the text data file is downloaded.

10. The method for installing the application according to claim 9, wherein the selecting list having the recommended text editors provides a text editor or a new version of text editor.

11. A computer system used when a file is downloaded via the Internet and when the file is used, the computer system comprising:
a network device downloading an application via an Internet, wherein the application includes a first user information;
a storage device connected to the network device and used for storing the downloaded application; and
a user information reading unit connected to the storage device, wherein when the network device finishes downloading the application, the user information reading unit reads the first user information included in the application and installs the application according to the first user information.

12. The computer system according to claim 11, wherein the first user information includes an application installing program code.

13. The computer system according to claim 11, wherein the user information reading unit is triggered by an application uninstalling command to read the first user information included in the application and uninstall the application according to an application uninstalling program code included in the first user information.

14. The computer system according to claim 11, wherein the application downloaded by the network device includes a multimedia audio/video file, and the multimedia audio/video file includes a second user information.

15. The computer system according to claim 14, wherein the user information reading unit reads the second user information included in the multimedia audio/video file after the multimedia audio/video file is downloaded and provides a selecting list having recommended multimedia player applications.

16. The computer system according to claim 15, wherein the multimedia audio/video file is an audio file, and the selecting list having the recommended multimedia player applications provides a music player application or a new version of music player application to allow the user to select and download.

17. The computer system according to claim 15, wherein the multimedia audio/video file is an image file, and the selecting list having the recommended multimedia player application provides an image display application or a new version of image display application to allow the user to select and download.

18. The computer system according to claim 11, wherein the application downloaded by the network device comprises a text data file, and the text data file includes a third user information.

19. The computer system according to claim 18, wherein after the text data file is downloaded, the user information reading unit reads the third user information included in the text data file and provides a selecting list having recommended text editors.

20. The computer system according to claim 19, wherein the selecting list having the recommended text editors provides at least a text editor or a new version of text editor.
